(19) United States
(12) Patent Application Publication
(10) Pub. No.: US 2002/0070279 A1
(43) Pub. Date: Jun. 13, 2002

(54) Methods and apparatus for illuminating a transaction card

(76) Inventor: Alan J. Zausner, Rhinebeck, NY (US)

Correspondence Address: Snell & Wilmer, LLP, One Arizona Center, 400 E. Van Buren Street, Pheonix, AZ, 85004-2202, US

(21) Appl. No.: 09/734,098

(22) Filed: Dec. 11, 2000

Related U.S. Application Data
(60) Provisional application No. 60/171,689, filed on Dec. 21, 1999.

(51) Int. Cl. G06K 19/06

(52) U.S. Cl. 235/490

(57) ABSTRACT

The activation source creates or activates a visual/audible signal in an acceptance device upon an activating circumstance. The activating circumstance may include a security condition, a credit limit, a user identification, a vendor identification, communication between the acceptance device and the transaction card, selection of one or more data profiles, approval or rejection to conduct a transaction, reaching of a purchase limit, denoting a product or transaction card type, awarding of a reward, or getting close to a credit limit or award. The activation source may cause an illumination, sound, or other indicia. As such, the activation source may illuminate a transaction card upon receipt of an activating circumstance.

### RELATED APPLICATIONS

This patent application claims priority to, and the benefit of, the provisional patent application entitled “Illumination Reader” filed on Dec. 21, 1999 as Serial No. 60/171,689, the entire contents of which are incorporated by reference.

### FIELD OF THE INVENTION

The present invention generally relates to a transaction card system and method, and more particularly, to a system and method for the illumination of a transaction card.

### BACKGROUND OF THE INVENTION

A transaction card system 101 of FIG. 1 typically includes a transaction card 103 and an acceptance device 107. Transaction card system 101 may be used for point-of-sale transactions, on-line purchasing of goods or services, accessing information, identification, accessing a building or room and/or the like. As such, transaction card 103 may be a smart card, a debit card, an access card, a credit card, a charge card, a personal digital assistant and/or the like. For example, transaction card 103 communicates with other devices and houses information via a device 105, such as a magnetic stripe, bar code, integrated circuit and/or the like. Device 105 may house information, set parameters for a transaction, provide a means of communication with other devices, and/or otherwise control or affect the transaction. Device 105 interacts with acceptance device 107 via communication means 109. Upon sliding transaction card 103 along communication means 109, inserting card 103 into communication means 109 or otherwise interfacing with communication means 109, device 105 may provide and/or receive information from a computer means 111 via acceptance device 107. Acceptance device 107 may be coupled to computer means 111, which communicates information to and/or from acceptance device 107.

For example, if transaction card 103 is a smart card interacting with computer means 111 via communication means 109, the available funds for a purchase stored on the smart card may be confirmed, a purchase made, and the purchase price subtracted from the available funds on the smart card. However, if the available funds are not commensurate with the purchase price, a purchase limit has been reached, a prohibited vendor has been solicited, a particular vendor or user has been identified, and/or another activating circumstance, for example, a method and apparatus for communicating such circumstances is desirable.

Various smart card systems include “Smart Card Authentication System Comprising Means For Converting User Identification And Digital Signature To Pointing Device Position Data And Vice Versa Using LUT”, Smith, U.S. Pat. No. 6,055,592, issued Apr. 25, 2000, and “Keying Notches For Side Contacts On A Thin Form Factor Computer”, Scheer et al., U.S. Pat. No. 5,619,660, issued Apr. 8, 1997, which are hereby incorporated by reference. Smart cards and various applications are discussed in W. RANKL & W. EFFING, SMART CARD HANDBOOK (1997), which is hereby incorporated by reference. In addition, typical smart card acceptance devices include AMC Model 171 Smart Card/Magstripe Insert Reader/Writer, Cardcom Technology KDR-1000 Series Manual Swipe Reader, Cardcom Technology KDR/M-9100 Series Hybrid Reader, Cardcom Technology KDR/M-5600 Series Compact Size Motorized Insertion Reader, Cardcom Technology KT-1000/2000 Series Manual Swipe Card Reader, and/or the like.

### SUMMARY OF THE INVENTION

An acceptance device is in communication with an activation source, wherein the activation source creates or activates a visual/audible signal upon an activating circumstance. The activating circumstance may include at least one of a security condition, a credit limit, a user identification, a vendor identification, communication between the acceptance device and the transaction card, selection of one or more data profiles, approval or rejection to conduct a transaction, reaching of a purchase limit, denoting a product or transaction card type, awarding of a reward, getting close to a credit limit or award, and/or the like. The activation source may cause an illumination, sound, or other indicia. As such, the activation source may illuminate a transaction card upon receipt of an activating circumstance.

### BRIEF DESCRIPTION OF THE DRAWING FIGURES

The subject invention will hereinafter be described in the context of the appended drawing figures, wherein like numerals denote like elements, and:

FIG. 1 illustrates a prior art transaction card system;

FIG. 2 illustrates a transaction card system in accordance with an exemplary embodiment of the present invention;

FIG. 3 illustrates an acceptance device in accordance with an exemplary embodiment of the present invention,

FIG. 4 is a flowchart illustrating a method for illuminating a transaction card in accordance with an exemplary embodiment of the present invention; and

FIG. 5 is a flowchart illustrating a method for activating a visual/audible signal in accordance with an exemplary embodiment of the present invention.

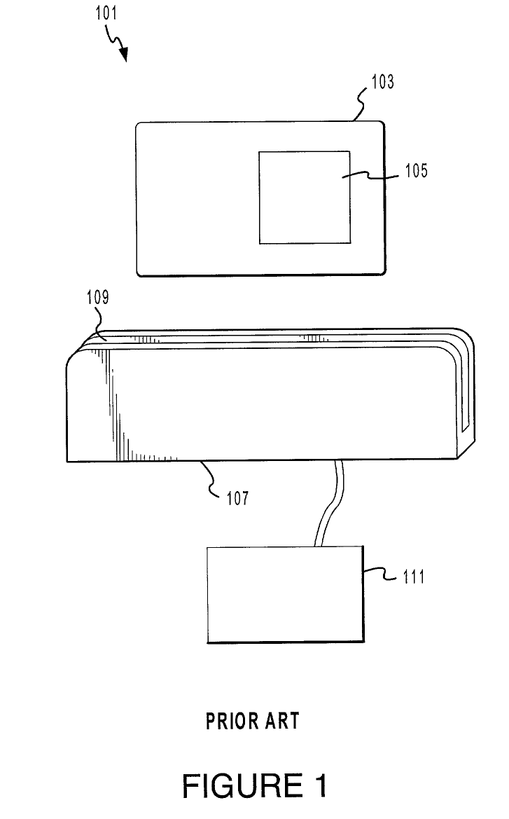

### DETAILED DESCRIPTION OF EXEMPLARY EMBODIMENTS

The present invention may be described in terms of functional block components and various processing steps. It should be appreciated that such functional blocks may be realized by any number of hardware and/or software components configured to perform the specified functions. For example, the present invention may employ various integrated circuit components, e.g., memory elements, digital signal processing elements, look-up tables, and the like, which may carry out a variety of functions under the control of one or more microprocessors or other control devices. In addition, those skilled in the art will appreciate that the present invention may be practiced in any number of data communication contexts and that the various systems described are merely exemplary applications for various aspects of the invention. Further, it should be noted that the present invention may employ any number of conventional techniques for data transmission, training, signal processing and conditioning, and the like. For a basic introduction of cryptography, please review a text written by Bruce Schneider which is entitled “Applied Cryptography: Protocols, Algorithms, And Source Code In C,” published by John Wiley & Sons (second edition, 1996), which is hereby incorporated by reference. Such general techniques that are known to those skilled in the art are not described in detail herein.

It will be appreciated, that many applications of the present invention could be formulated. One skilled in the art will appreciate that the network may include any system for exchanging data or transacting business, such as the Internet, an intranet, an extranet, WAN, LAN, satellite communications, and/or the like. The users may interact with the system via any input device such as a keyboard, mouse, kiosk, personal digital assistant, handheld computer (e.g., Palm Pilot®), cellular phone and/or the like. Similarly, the invention could be used in conjunction with any type of personal computer, network computer, workstation, minicomputer, mainframe, or the like running any operating system such as any version of Windows, Windows NT, Windows2000, Windows 98, Windows 95, MacOS, OS/2, BeOS, Linux, UNIX, or the like. Moreover, although the invention is frequently described herein as being implemented with TCP/IP communications protocols, it will be readily understood that the invention could also be implemented using IPX, Appletalk, IP-6, NetBIOS, OSI or any number of existing or future protocols. Moreover, the system contemplates the use, sale or distribution of any goods, services or information over any network having similar functionality described herein.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

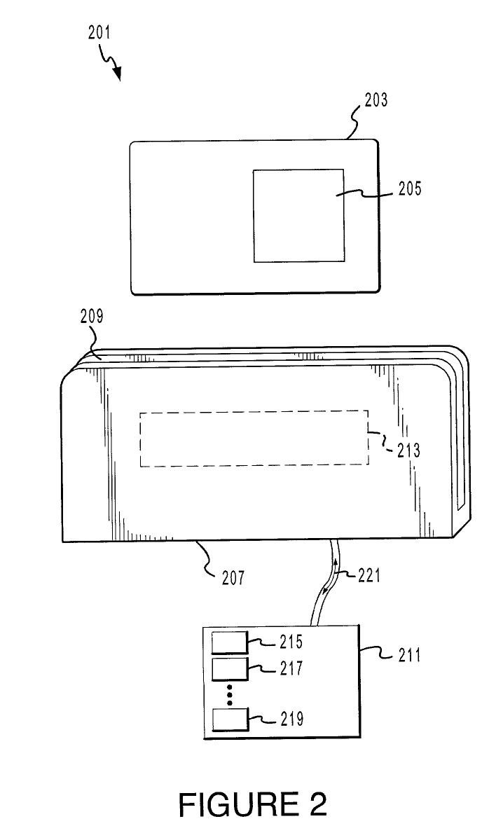

A transaction card system 201 in accordance with an exemplary embodiment of the present invention is illustrated in FIG. 2. Transaction card system 201 includes a transaction card 203 and an acceptance device 207. Transaction card 203 is any hardware and/or software configured to store or display information such as, for example, a smart card, debit card, charge card, credit card, point-of-sale card, identification card, access card, storage card, a loyalty card, a stored value card, personal digital assistant (e.g., Palm Pilot®) and/or the like. In addition, transaction card 203 includes at least one of an opaque material, a translucent material, a transparent material, a clear material, a non-translucent material, a non-transparent material, a plastic material, a polyvinyl chloride (PVC) material, electronic components, and/or a metal material. Transaction card 203 includes an information device 205, such as a magnetic stripe, bar code, symbol, account number, integrated circuit and/or any other device configured to communicate, store and/or receive information.

Acceptance device 207 is any hardware and/or software configured to accept information, In an exemplary embodiment, acceptance device 207 is a transaction card reader/writer configured to accept transaction card 203. Acceptance device 207 interacts with transaction card 203 via a communication means 209. Communication means 209 is any hardware and/or software configured to interface with transaction card 203.

As transaction card 203 interacts, interfaces or otherwise communicates with acceptance device 207, information device 205 may provide, receive, and otherwise communicate information to and/or from a computer means 211. As such, a visual/audible signal 221 may be transmitted to or from acceptance device 207 via computer means 211. The transmission of visual/audible signal 221 is illustrated from computer means 211 to acceptance device 207, or vice-versa; however, visual/audible signal 221 may also solely exist within acceptance device 207 or computer means 211, for example. Transaction card 203 may slide along, into or otherwise interface with, communication means 209 in order to provide and/or receive information to and/or from computer means 211. As transaction card 203 interacts with computer means 211 via acceptance device 207, an activation source 213 of acceptance device 207 may activate visual/audible signal 221 and/or transaction card 203. For example, upon receiving at least a portion of transaction card 203, the activation (e.g., illumination) of transaction card 203 may be triggered via activation source 213 (e.g., switch or broken beam). As such, if transaction card 203 is transparent, translucent or the like, transaction card 203 may be illuminated or its appearance altered in some manner.

The interaction between transaction card 203 and communication means 209 may be magnetic, electrical, optical, infrared, wireless, and/or the like. In addition, the interaction between communication means 209 and computer means 211 may be magnetic, electrical, optical, infrared, wireless, and/or the like. As such, visual/audible signal 221 may be magnetic, electrical, optical, wireless, and/or the like. Transaction card 203 may be removably or permanently coupled to activation source 213 such that activation source 213 activates or triggers (e.g., illuminates at least a portion of transaction card 203, sounds, or otherwise communicates) upon an activating circumstance. As such, visual/audible signal 221 may activate upon the activating circumstance. For example, depending on the internal molecular structure of transaction card 203, activation source 213 may excite, change or disclose an embedded design within transaction card 203. In this way, the embedded design may be used for security, product enhancement, and/or the like. Activation may also include interference with activation source 213 (e.g., interference with an electrical signal or optical beam), communication between acceptance device 207 and transaction card 203 (e.g., receiving at least a portion of transaction card 203 into acceptance device 207), another type of activation, and/or the like depending on the needs of transaction card system 201.

The activating circumstance and/or other triggering may indicate approval or rejection to conduct a transaction, identification of a user or vendor, reaching of a credit or purchase limit, denoting a product or transaction card type, awarding of a reward, getting close to a credit limit or award, and/or selection of one or more data profiles 215, 217, and 219 defining one or more activating circumstances. Data profiles 215, 217, and 219 may include any number of data profiles and may be configured to include any number of activating circumstances. Data profiles 215, 217, and 219 may be housed in computer means 211 (e.g., such as data stored in a memory device) and manipulated via software in order to meet the needs of transaction card system 201. Data profiles may include any information about the user, the website or any other entity, person or database which may qualify as an activating circumstance, such as, for example, relevant date information (e.g., birthday, anniversary, etc.), incorrect or correct data in a form, unacceptable or acceptable websites, multiple prior purchases of a specific product, multiple prior purchases from a specific vendor, and/or the like.

Activation source 213 may be configured to operate by illuminating, blinking, displaying color, changing color, and/or communicating sound depending on the needs of transaction card system 201. For example, transaction card system 201 may be configured such that activation source 213 illuminates, blinks, displays color, changes color, and/or communicates sound upon an activating circumstance. Accordingly, the activating circumstances (or the software defining the activating circumstances) may interface with the hardware of acceptance device 207 based on the needs of transaction card system 201. Further examples of activating circumstances include a security condition, a credit limit, a user identification, a vendor identification, and/or the like. Accordingly, transaction card 203 may be used for credit, charge, debit, access, point-of-sale, and/or the like. Such activating circumstances may be integrated into transaction card system's 201 software, for example, or include external software depending on the needs of transaction card system 201.

Acceptance device 207 may include a card reader/writer, a point-of-sale terminal, an access terminal, and/or the like. Acceptance device 207 may be incorporated within computer means 211 or remain a separate element, and is illustrated separately for ease of discussion. Activation source 213 may include an illumination source, a sound source, a visual source, and/or the like. For example, activation source 213 may include an incandescent source, a piezoelectric source, a solid state based source, and/or the like. An incandescent source may include, e.g., a neon source, a plasma based source, a tungsten source, and/or the like. A solid state based source may include, e.g., a light emitting diode, a multi-spectral light emitting diode, a laser, an electro-luminescent source, and/or the like. Activation source 213 may be incorporated within acceptance device 207 or remain a separate element depending upon the need of transaction card system 201. As such, depending on the type of acceptance device 207 and transaction card 203, drive circuits and the like for driving activation source 213 may be integrated within acceptance device 207, or alternatively, separate elements.

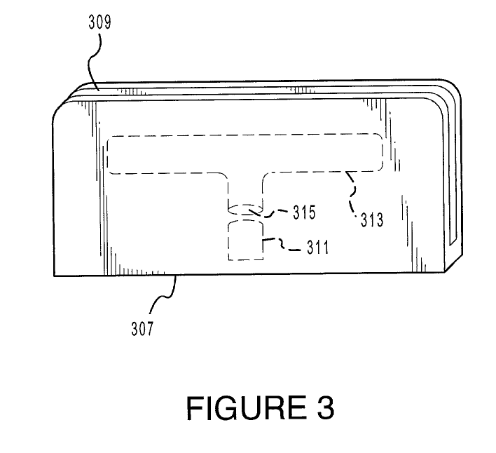

FIG. 3 illustrates an acceptance device 307 in accordance with an exemplary embodiment of the present invention. Acceptance device 307 includes a light pipe (or lens assembly) 313 by which an activation source 311 may illuminate a transaction card (not shown). Light pipe 313 expands, diffuses, and/or uniformly distributes the illumination provided by activation source 311 onto the transaction card. As activation source 311 shines on an opening 315 of light pipe 313, the illumination from activation source 311 is filtered through light pipe 313 before illuminating the transaction card. As such, the transaction card is uniformly illuminated. Alternatively, or in conjunction, activation source 311 may illuminate, activate, sound, or otherwise communicate an activating circumstance via acceptance device 307. For example, acceptance device 307 may include at least one of an opaque material, a translucent material, a transparent material, a clear material, a non-translucent material, a plastic material, a polyvinyl chloride (PVC) material, or a metal material. As such, activation source 311 may illuminate acceptance device 307 alone or in combination with the transaction card.

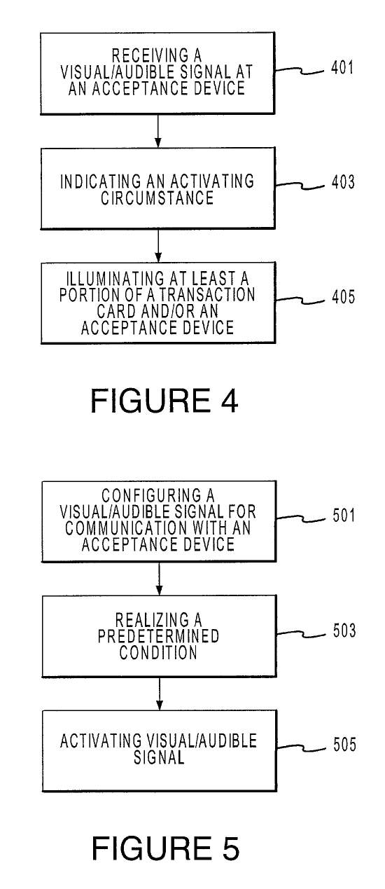

FIG. 4 illustrates a flowchart for a method for illuminating transaction card 203 in accordance with an exemplary embodiment of the present invention. The method includes receiving visual/audible signal 221 at acceptance device 207, 307 (step 401). Visual/audible signal 221 may indicate an activating circumstance (step 403). The activating circumstance may include at least one of a security condition, a credit limit, a user identification, a vendor identification, communication between the acceptance device and the transaction card, selection of one or more data profiles, approval or rejection to conduct a transaction, reaching of a purchase limit, denoting a product or transaction card type, awarding of a reward, getting close to a credit limit or award, and/or the like. Upon receiving visual/audible signal 221, at least a portion of at least one of transaction card 203 or an acceptance device 207, 307 is illuminated (step 405). Illumination of transaction card 203 may be via interfacing between an activation source 213, 311, transaction card 203, and/or acceptance device 207, 307. Activation source 213, 311 may operate by at least one of illuminating, blinking, displaying color, changing color, or communicating sound depending on the needs of transaction card system 201.

In another exemplary embodiment of the present invention, FIG. 5 illustrates a flowchart for a method for activating visual/audible signal 221. The method includes receiving visual/audible signal 221 at acceptance device 207, 307 (step 501), wherein receiving visual/audible signal 221 at acceptance device 207, 307 may include configuring visual/audible signal 221 for communication with acceptance device 207, 307, and/or reading information housed in transaction card 203. Upon realizing an activating circumstance (step 503), visual/audible signal 221 is activated (step 505). The activating circumstance may include at least one of a security condition, a credit limit, a user identification, a vendor identification, communication between the acceptance device and the transaction card, selection of one or more data profiles, approval or rejection to conduct a transaction, reaching of a purchase limit, denoting a product or transaction card type, awarding of a reward, getting close to a credit limit or award, and/or the like. Activation source 213, 311 may operate by illuminating, blinking, displaying color, changing color, and/or communicating sound depending on the needs of transaction card system 201.

Thus, the present invention provides methods and apparatus for activating a visual/audible signal, such as activating an activation source to illuminate a transaction card. The transaction card interfaces with an activation source, which illuminates the transaction card upon realizing an activating circumstance or other form of triggering. A computer means interacts with the transaction card via an acceptance device, for example, in order to provide and/or receive information. The interaction of the computer means and the transaction card may include interference with the activation source, communication with the acceptance device, and/or selection of one or more data profiles defining one or more activating circumstances. Upon the determination of an activating circumstance, the activation source may illuminate, blink, display color, and/or communicate sound in order to indicate the activating circumstance.

Although the invention has been described herein with reference to the appended drawing figures, it will be appreciated that the scope of the invention is not so limited. Various modifications in the design and implementation of various components and method steps discussed herein may be made without departing from the spirit and scope of the invention, as set forth in the appended claims. It should be understood that the exemplary methods/processes illustrated may include more or less steps or may be performed in the context of a larger processing scheme. Furthermore, the various flowcharts presented in the drawing figures are not to be construed as limiting the order in which the individual process steps may be performed. Steps recited in any method claims may be executed in any order. No element described herein is necessary for the practice of the invention, unless the element is expressly described herein as “essential” or “required”.

What is claimed is:

1. A transaction card system, comprising:
an acceptance device configured for interfacing with at least a portion of at least one of a translucent transaction card or a transparent transaction card; and
an activation source for illuminating at least a portion of the transaction card upon an activating circumstance.

2. The system of claim 1, further comprising a visual/audible signal in communication with the activation source, wherein the visual/audible signal activates the activation source upon the activating circumstance.

3. The system of claim 2, wherein the activation source may operate by illuminating, blinking, displaying color, changing color, or communicating sound.

4. The system of claim 2, wherein the activating circumstance includes at least one of a security condition, a credit limit, a user identification, a vendor identification, communication between the acceptance device and the transaction card, selection of one or more data profiles, approval or rejection to conduct a transaction, reaching of a purchase limit, denoting a product or transaction card type, awarding of a reward, or getting close to a credit limit or award.

5. The system of claim 1, wherein the activation source illuminates at least a portion of the acceptance device upon the activating circumstance.

6. The system of claim 1, wherein the transaction card comprises at least one of a smart card, a debit card, a point-of-sale card, an access card, a storage card, a loyalty card, a stored value card, or a credit card.

7. A transaction card system, comprising:
an acceptance device configured for communication with a transaction card; and
an activation source for activating the transaction card upon an activating circumstance, wherein the activating circumstance includes at least one of a security condition, a credit limit, a user identification, a vendor identification, communication between the acceptance device and the transaction card, selection of one or more data profiles, approval or rejection to conduct a transaction, reaching of a purchase limit, denoting a product or transaction card type, awarding of a reward, or getting close to a credit limit or award.

8. The transaction card system of claim 7, wherein at least a portion of the transaction card includes at least one of an opaque material, a translucent material, a transparent material, a clear material, a non-translucent material, a non-transparent material, a plastic material, a polyvinyl chloride (PVC) material, or a metal material

9. A computer implemented method for illuminating a transaction card, comprising the steps of:
receiving a visual/audible signal at an acceptance device, wherein the visual/audible signal indicates an activating circumstance; and
illuminating at least a portion of the transaction card upon receiving the visual/audible signal.

10. The computer implemented method of claim 9, further comprising the step of illuminating the transaction card via an activation source upon realizing the activating circumstance.

11. A method for illuminating a transaction card, comprising the steps of:
interfacing between an activation source and the transaction card; and
illuminating at least a portion of the transaction card via the activation source upon realizing an activating circumstance.

12. The method of claim 11, wherein the activating circumstance includes at least one of a security condition, a credit limit, a user identification, a vendor identification, communication between the acceptance device and the transaction card, selection of one or more data profiles, approval or rejection to conduct a transaction, reaching of a purchase limit, denoting a product or transaction card type, awarding of a reward, or getting close to a credit limit or award.

13. The method of claim 11, further comprising the steps of:
interfacing between an acceptance device, the activation source, and the transaction card,
receiving at least a portion of the transaction card into the acceptance device; and
illuminating at least a portion of at least one of the transaction card or the acceptance device via the activation source upon receiving at least a portion of the transaction card into the acceptance device.

14. The method of claim 13, wherein the acceptance device includes a smart card reader.

15. The method of claim 11, wherein the activation source may operate by at least one of illuminating, blinking, displaying color, changing color, or communicating sound.

16. The method of claim 11, wherein the transaction card comprises at least one of a smart card, a debit card, an access card, or a credit card.

17. The method of claim 11, further comprising the steps of:
interfacing between an acceptance device and the transaction card; and
illuminating at least a portion of the transaction card via the activation source upon receiving at least a portion of the transaction card into the acceptance device, wherein the activation source may at least one of illuminate, blink, display color, changes color, or display sound.

18. A computer system, comprising:
a computer means configured for receiving at least a portion of a transaction card; and
an activation source, coupled to the computer means, wherein the computer means triggers the illumination of at least a portion of the transaction card via the activation source.

19. The system of claim 18, wherein triggering the illumination of the transaction card includes at least one of:
interference with a signal of the activation source;
interfacing with an acceptance device of the computer means upon receiving at least a portion of the transaction card into the acceptance device; or
reading information from one or more data profiles defining one or more illuminating circumstances.

20. The system of claim 18, wherein the computer means and the activation source include a smart card reader.

21. The system of claim 18, wherein the transaction card includes at least one of an opaque material, a translucent material, a transparent material, a clear material, a non-translucent material, a non-transparent material, a plastic material, a polyvinyl chloride (PVC) material, or a metal material
